(19) United States
(12) Patent Application Publication
(10) Pub. No.: US 2008/0036858 A1
(43) Pub. Date: Feb. 14, 2008

(54) On-Deman Vehicle Entertaining Device

(76) Inventor: Juen- Tien Peng, Chung Li (TW)

Correspondence Address: HDSL, 4331 STEVENS BATTLE LANE, FAIRFAX, VA, 22033, US

(21) Appl. No.: 11/382,509

(22) Filed: May 10, 2006

(51) Int. Cl. H04N 7/18

(52) U.S. Cl. 348/118

(57) ABSTRACT

A on-demand video entertaining device includes a video program unit, which has a plurality of video programs each providing a video signal, a modulation unit to modulate the video signal provided by the video program unit and output the modulated signal through a coaxial cable, a video device unit installed in the vehicle having a plurality of demodulators, processors, a screen, a controller and a pair speaker. The demodulators receive the modulated signal transmitted by the coaxial cable and demodulate the modulated signal into a TV image signal and a dual audio channel signal, which are then transmitted to the screen and the speakers. The controller transmits the operation commands for channel selection and volume adjustment to the processor. The processor controls the demodulators, the screen and screen to perform the corresponding action of the commands. Thereby, multiple video entertainment programs can be provided to the passengers on board. The passengers can also browse the outside sceneries from different angles and directions.

### BACKGROUND

The present invention relates in general to a video device, and more particularly, to an on-demand vehicle video entertainment device providing multiple video programs and allowing the passengers to view the outside sceneries of the vehicle.

To entertain the passengers through a long journey, many vehicles such as buses or large size coaches are equipped with device to play a video program or a film. However, most of the video devices can only provide a single program only. Although the on-demand entertaining systems have been very popular in commercial aircrafts, the cost of such systems is still too high to apply in vehicles such as buses or coaches. In addition, the seat location in the vehicle often limits the passengers to enjoy the sceneries outside of the vehicle. There is also currently lack of the facilitate allowing the passengers in all seat locations to enjoy the sceneries from different angles and view points.

Accordingly, there is a substantial need to develop a low-cost on-demand entertainment device that does not only provide multiple video programs, but is also operative to reproduce the sceneries outside the vehicle from various angles and directions, such that the passengers can be better entertained and enjoy more of the journey.

### BRIEF SUMMARY

A low-cost on-demand vehicle entertaining device is provided to provide multiple video programs for the passengers to select.

The on-demand vehicle entertaining device does not only provide multiple video programs for the passengers to select, but is also operative to reproduce and display the sceneries outside the vehicle from various angles and directions.

The on-demand video entertaining device of the invention utilizing the characteristic of the modulator to receive several signals simultaneously, includes a video program unit, which has a plurality of video programs each providing a video signal, at least one modulation unit to modulate the video signal provided by the video program unit and output the modulated signal through a coaxial cable, a video device unit installed in the vehicle having a plurality of demodulators, processors, a screen, a controller and a pair speaker. The demodulators receive the modulated signal transmitted by the coaxial cable and demodulate the modulated signal into a TV image signal and a dual audio channel signal, which are then transmitted to the screen and the speakers. The controller transmits the operation commands for channel selection and volume adjustment to the processor. The processor controls the demodulators, the screen and screen to perform the corresponding action of the commands. Thereby, multiple video entertainment programs can be provided to the passengers on board. The passengers can also browse the outside sceneries from different angles and directions.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a block diagram of the on-demand entertaining device.

### DETAILED DESCRIPTION

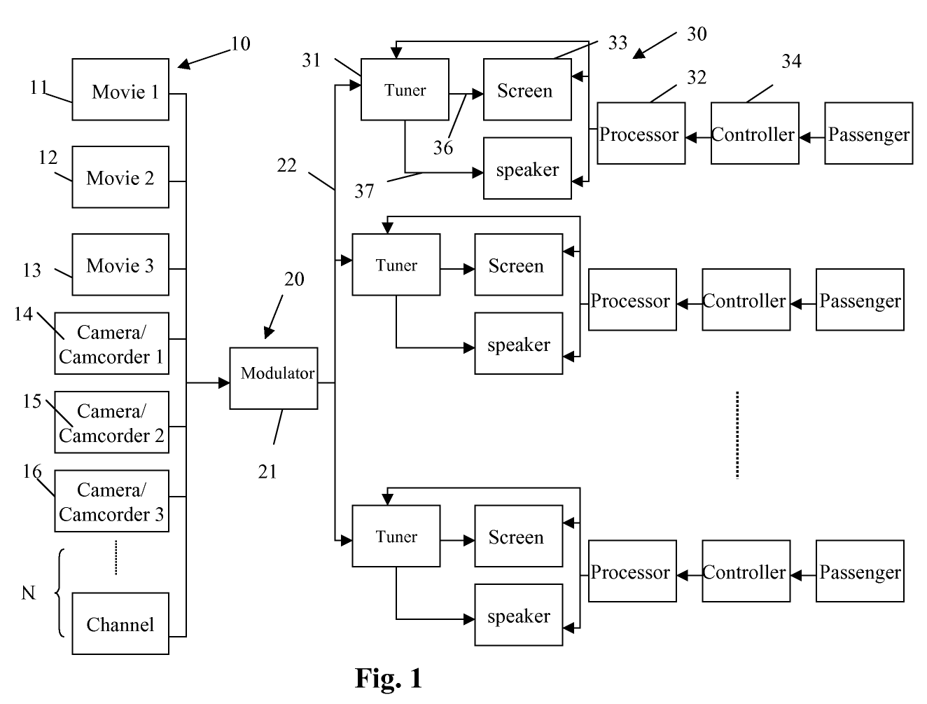

As shown in FIG. 1, the on-demand vehicle entertaining device includes a video program unit 10, a modulation unit 20, and a plurality of video device units 30. The video program unit 10 includes movies 11, 12, music 13, or camcorders 14, 15 and 16, and N channels of video programs. The movies 11, 12 and 13 may be displayed by video player such as DVD. The or camcorders 14, 15 and 16 can be installed on the vehicle at various locations such as the left and right, front and rear corners or various sides of the vehicle to capture the image of the sceneries from various angles and directions. The N channels include a plurality of wireless televisions or other video programs. The video program unit 10 transmits the video signal of the movie, music, sceneries or the wireless television to the modulation unit 20. The modulation unit 20 has a modulator to modulate the video signal and transmits the modulated signal to the video device unit 30 through a coaxial cable 22. The video device unit 30 includes a plurality of demodulators 31, a processor 32, a screen 33, a controller 34, and at least one speaker 35. The demodulators 31 (or the television tuner) transmit the video signal transmitted from the video program unit 10 and demodulate the video signal into CVBS television video signal 36 and dual-channel audio signal 37 and transmit the video signal 36 and the audio signal 37 to the screen 33 and the speakers 35, respectively. Through the controller 34 such as a wired or remote controller, the passengers can select the program, adjusts the volume or switch the programs. Once a command generated and transmitted from the controller 34 is received, the processor 32 will control the demodulators 31, screen 33 and speakers 35 to perform the corresponding action. The speakers 35 can also be replaced or used in association with a pair of ear phones to avoid interfere individual passengers who are not watching or listening to the same program.

Currently, the basic demodulator 21 is operative to receive twelve video signals simultaneously. That is, the on-demand video entertaining device may be equipped with at least twelve video programs allowing the passenger to select. It will be appreciated that demodulators that support more or less channels and the number of the demodulators can be modified according to specific need without exceeding the scope of the current invention.

The vehicle on-demand video entertaining device as discussed above does not only allow individual passenger to select various types of programs, but also allow the passenger to enjoy the sceneries along the journeys without being restricted by the specific seat location. Moreover, the vehicle on-demand video entertaining device can be fabricated with a relative low cost, such that each passenger can enjoy an individual on-demand video entertaining device like those provided in the commercial aircrafts.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An on-demand video entertaining device, comprising:
a video program unit, including a plurality of programs and operative to generate a corresponding video signal for each program;
a modulation unit for modulating the video signal and outputting the video signal; and
a video device unit, comprising:
a controller allowing a passenger or user to select among the programs;
at least one demodulator for demodulating the modulated video signal into a video signal and an audio signal;
a screen for displaying images carried by the demodulated video signal; and
a audio device for generating sounds carried by the demodulated audio signal.

2. The device of claim 1, wherein the video program unit includes at least one camera or camcorder installed at various locations of the vehicle.

3. The device of claim 1, wherein the programs include movies, music, and images captured by at least one camera or camcorder.

4. The device of claim 1, wherein the controller includes a wired or remote control.

5. The device of claim 1, wherein the audio device includes at least one speaker or ear phone.

6. The device of claim 1, wherein the video device unit further comprises a processor operative to control the demodulator, the screen and the audio device to perform action corresponding to the selected programs.

7. The device of claim 1, further comprising a coaxial cable for transmitting the video signal from the demodulation unit to the video device unit.

8. An on-demand video entertaining device, comprising:
a video program unit, including a plurality of programs and operative to generate a corresponding video signal for each program;
a plurality of modulation units each for modulating the video signal and outputting the video signal; and
a video device unit, comprising:
a controller allowing a passenger or user to select among the programs;
a plurality of demodulators for demodulating the modulated video signals into a video signals and an audio signals, respectively;
a screen for displaying images carried by the demodulated video signal; and
a audio device for generating sounds carried by the demodulated audio signal.

9. The device of claim 8, wherein the video program unit includes at least one camera or camcorder installed at various locations of the vehicle.

10. The device of claim 8, wherein the programs include movies, music, and images captured by at least one camera or camcorder.

11. The device of claim 8, wherein the controller includes a wired or remote control.

12. The device of claim 8, wherein the audio device includes at least one speaker or ear phone.

13. The device of claim 8, wherein the video device unit further comprises a processor operative to control the demodulator, the screen and the audio device to perform action corresponding to the selected programs.

14. The device of claim 8, further comprising a coaxial cable for transmitting the video signal from each demodulation unit to the video device unit.

15. An on-demand entertaining device installed in a vehicle, comprising:
a video program unit, including a plurality of pre-stored video and/or audio programs;
an image capture device installed on the vehicle; and
a video unit for displaying program or image provided by video program unit and the image capture device.

16. The device of claim 15, wherein the image capture device includes a camera or a camcorder.

17. The device of claim 15, wherein the video unit includes a screen and at least one speaker.
